(19) United States
(12) Patent Application Publication
(10) Pub. No.: US 2009/0028024 A1
(43) Pub. Date: Jan. 29, 2009

(54) RECORD CARRIER, RECORDING METHOD AN DPLAYBACK DEVICE FOR CONTROLLING COPYRIGHT

(75) Inventors: Josephus Arnoldus Kahlman, Eindhoven (NL); Bart Van Rompaey, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,955

(22) PCT Filed: Aug. 3, 2005
(86) PCT No.: PCT/IB05/52597

§ 371 Date: Feb. 20, 2007

(30) Foreign Application Priority Data
Aug. 27, 2004 (EP) 04104128.6

(51) Int. Cl. G11B 27/36

(52) U.S. Cl. 369/53.41

(57) ABSTRACT

When duplicating the record carrier the angle between the sync words S1 S2 can be preserved at the cost of a change in bit length, or the bit length can be preserved at the expense of changes in the angle between the sync words S1 S2. Consequently a playback device that checks for both changes in the angle between the sync words S1 S2, or between other marks, and for changes in bit length can detect an illegally duplicated record carrier with a high certainty.

The invention relates to a record carrier comprising record carrier identification information, to a playback device comprising a retrieval device for retrieving record identification information from a record carrier and to a method for recording a record carrier comprising record carrier identification information.

Such a record carrier is known from the DVD record carrier where encrypted data and a key for decrypting the encrypted data are recorded on the record carrier. Information about this encryption and decryption is publicly available by virtue of the computer program DeCSS that is currently widely used to rip, i.e. decrypt, DVDs.

The record carrier can be identified as an illegal copy if on the duplicated record carrier the encryption is missing and/or the key is missing. However if a method is used to duplicate the record carrier in a bit by bit fashion both the key and the encrypted data are copied to the duplicated record carrier and no distinction can be made between original record carrier and duplicated record carrier.

Mastering machines can be used to duplicate an original record carrier, which is especially troubling because the physical appearance of the duplicated record carrier can be made to closely resemble the original record carrier. For instance the reflectivity of the recording layer of the original ROM type record carrier will be identical to the duplicated record carrier because the duplicated record carrier is also of the ROM type since it is made using a die created by the mastering machine. In addition the bit by bit duplication is independent of the format and encryption of the record carrier used and is thus equally applicable to future record carriers regardless of format or encryption.

The use of a key recorded on the record carrier and the encryption of the data on the record carrier using that key is clearly not sufficient to prevent the illegal duplication using a mastering machine.

It is an objective of the present invention to provide a record carrier that after duplication yields a duplicated record carrier that reveals to a playback device that it is an illegal record carrier.

To achieve this objective the record carrier is characterized in that the record carrier identification comprises a value indicating a physical parameter of that record carrier and in that the physical parameter represents a relation between a first pre-defined position on the record carrier and a second pre-defined position on the record carrier.

The physical parameter is affected by the duplication process while the content of the record carrier is copied literally and consequently there will be a disparity between the value of the physical parameter stored on the record carrier and the actual physical parameter as it exists on the record carrier after duplication.

An embodiment of the record carrier is characterized in that the physical parameter is an angle between a first line crossing the first pre-defined position perpendicular to a reading direction and a second line crossing the second pre-defined position perpendicular to the reading direction.

Mastering machines can be operated in two modes:

the axial and radial motors can be locked

the axial and radial motors can be unlocked

When the axial and radial motors are unlocked the variations between the mastering machines will result in a shift of the second predefined position relative to the first predefined position. This changes the value of the angle as defined by the claim compared to the stored value, indicating that the duplicated record carrier is an illegal duplication.

A further embodiment of the record carrier is characterized in that the physical parameter is a difference between a first radius at which the first pre-defined position is located and a second radius at which the second pre-defined position is located.

Mastering machines can be operated in two modes:

the axial and radial motors can be locked

the axial and radial motors can be unlocked

When the axial and radial motors are unlocked the variations between the mastering machines will result in a shift of the second predefined position relative to the first predefined position. This changes the second radius at which the second predefined position is located relative to the first radius where the first predefined position is located.

This change results in a difference between the actual physical parameter on the record carrier, the ratio of the two radii, compared to the stored value, indicating that the duplicated record carrier is an illegal duplication.

A further embodiment of the record carrier is characterized in that the physical parameter is a bit length.

When the record carrier is duplicated using a mastering machine where the axial and radial motors are locked the number of bits in a given track in one revolution will be constant. If that track is however shifted inward or outward compared to the original record carrier, a change in bit length will occur since the same number of bits will be distributed over a shorter or longer section of track.

A further embodiment of the record carrier is characterized in that the physical parameter is a number of bits per revolution.

When the record carrier is duplicated using a mastering machine where the axial and radial motors are unlocked the number of bits in a given track in one revolution cannot be controlled and will consequently vary. This results in a change of number of bits per revolution for a given track when compared to the track at the same position on the original record carrier.

A further embodiment of the record carrier is characterized in that the record carrier comprises a track with a shifted starting point relative to a standardized starting point on a standardized record carrier.

Besides the normal fluctuations that occur in the starting point when mastering a record carrier a shift of the starting point is introduced on the original record carrier. When such an original record carrier is duplicated the starting point will shift towards the starting point prescribed by the standard. Any shift of starting point can be detected as outlined above since at least one of the physical parameters will change compared to the value stored on the record carrier.

A further embodiment of the record carrier is characterized in that the shifted starting point is shifted in a direction towards an end of the track.

By shifting the start of the track towards the end of the track, the shift back as a result of the duplication will result in a record carrier where the duplicated data will still fit on the record carrier thus not upsetting the duplication process, yet the physical characteristic has changed to indicate the illegal status of the record carrier.

A playback device according to the invention is characterized in that the retrieval device is arranged to retrieve a value indicating a physical parameter of that record carrier and in that the physical parameter represents a relation between a first pre-defined position on the record carrier and a second pre-defined position on the record carrier and that the playback device further comprises a verification device for comparing the retrieved value to a measured value of the physical parameter as measured on the record carrier by a measuring device comprised in the playback device.

The playback device retrieves the value representing the physical parameter from the record carrier and compares this value to the measured value as measured on the record carrier. When the record carrier is an original record carrier the value and the measured physical parameter will match with a predefined margin.

When the record carrier is an illegal duplicated record carrier the value retrieved from the record carrier and the measured value will differ and the record carrier can be identified as an illegal duplicate record carrier.

The physical parameter is affected by the duplication process while the content of the record carrier is copied literally and consequently there will be a disparity between the value of the physical parameter stored on the record carrier and the actual physical parameter as it exists on the record carrier after duplication.

An embodiment of the playback device is characterized in that the physical parameter is an angle between a first line crossing the first pre-defined position perpendicular to a reading direction and a second line crossing the second pre-defined position perpendicular to the reading direction.

Mastering machines can be operated in two modes:

the axial and radial motors can be locked

the axial and radial motors can be unlocked

When the axial and radial motors are unlocked the variations between the mastering machines will result in a shift of the second predefined position relative to the first predefined position. This changes the value of the angle compared to the stored value, indicating that the duplicated record carrier is an illegal duplication. The playback device will detect the difference between the retrieved value as stored on the record carrier and the measured value as measured on the record carrier.

A further embodiment of the playback device is characterized in that the physical parameter is a difference between a first radius at which the first pre-defined position is located and a second radius at which the second pre-defined position is located.

Mastering machines can be operated in two modes:

the axial and radial motors can be locked

the axial and radial motors can be unlocked

When the axial and radial motors are unlocked the variations between the mastering machines will result in a shift of the second predefined position relative to the first predefined position. This changes the second radius at which the second predefined position is located relative to the first radius where the first predefined position is located.

This change results in a difference between the actual physical parameter on the record carrier, the ratio of the two radii, compared to the stored value, indicating that the duplicated record carrier is an illegal duplication. The playback device will detect the difference between the retrieved value as stored on the record carrier and the measured value as measured on the record carrier.

A further embodiment of the playback device is characterized in that the physical parameter is a bit length.

When the record carrier is duplicated using a mastering machine where the axial and radial motors are locked the number of bits in a given track in one revolution will be constant. If that track is however shifted inward or outward compared to the original record carrier, a change in bit length will occur since the same number of bits will be distributed over a shorter or longer section of track. This change can be easily detected by the playback device by comparing the bit length as measured on the record carrier to the value representing the bit length as retrieved from the record carrier.

A further embodiment of the playback device is characterized in that the physical parameter is a number of bits per revolution.

When the record carrier is duplicated using a mastering machine where the axial and radial motors are unlocked the number of bits in a given track in one revolution cannot be controlled and will consequently vary. This results in a change of number of bits per revolution for a given track when compared to the track at the same position on the original record carrier. This change can be easily detected by the playback device by comparing the number of bits per revolution as measured in a given section of the track on the record carrier to the value representing the number of bits per revolution as retrieved from the record carrier.

A further embodiment of the playback device is characterized in that it uses both the angle and the difference in radii, for instance the ratio of the radii, as a physical parameter to verify the record carrier.

A playback device verifying both a physical parameter related to the radii and a physical parameter relating to the angle is able to distinguish illegal duplicate record carrier from original record carrier regardless of whether the mastering machine was operating with the radial motor and the axial motor locked or with the radial motor and the axial motor unlocked. If the illegal duplicate record carrier was mastered using locked radial and axial motors a change in the angle will not occur but a change in the radii will be evident. If the illegal duplicate record carrier was mastered using unlocked radial and axial motors a change in the radii will not occur but a change in the angle will be evident. Thus the playback device is always able to detect an illegal duplicate record carrier.

A further embodiment of the playback device is characterized in that it uses both the bit length and the number of bits per revolution as a physical parameter to verify the record carrier.

A playback device verifying both a physical parameter related to the bit length and a physical parameter relating to the number of bits per revolution is able to distinguish illegal duplicate record carrier from original record carrier regardless of whether the mastering machine was operating with the radial motor and the axial motor locked or with the radial motor and the axial motor unlocked. If the illegal duplicate record carrier was mastered using locked radial and axial motors a change in the number of bits per revolution will not occur but a change in the bit length will be evident because the same number of bits will be stored in a longer or shorter section of the track. If the illegal duplicate record carrier was mastered using unlocked radial and axial motors a change in the bit length will not occur but a change in the number of bits per revolution will be evident. Thus the playback device is always able to detect an illegal duplicate record carrier.

A further embodiment of the playback device is characterized in that the verification device prevents an operation of the playback device if a difference is detected between the retrieved value and the measured value.

When an illegal duplicate record carrier is detected the verification device in the playback device will prevent the access to the data so that the copy right of that data cannot be violated.

A further embodiment of the playback device is characterized in that the retrieval device comprises a device for decrypting the value indicating a physical parameter of that record carrier when retrieving the value indicating a physical parameter of that record carrier from the record carrier.

One way in which the verification device can prevent access to the data is by preventing or inhibiting the decryption of the data by a decryption device in the playback device. It is thus prevented that access to the data is obtained when an illegal duplicate record carrier is detected.

The invention will now be described based on figures.

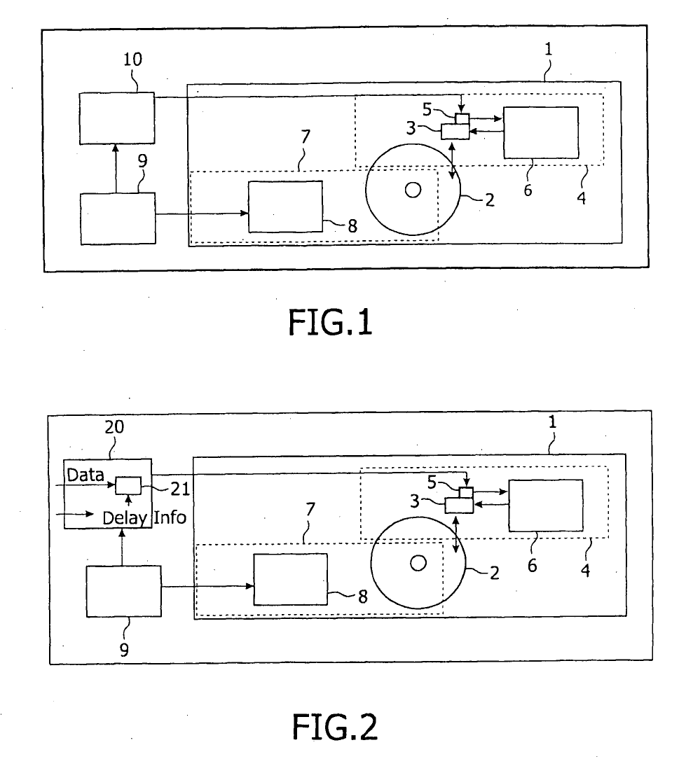

FIG. 1 shows a regular recording using a mastering machine.

FIG. 2 shows a recording according to the invention using a mastering machine.

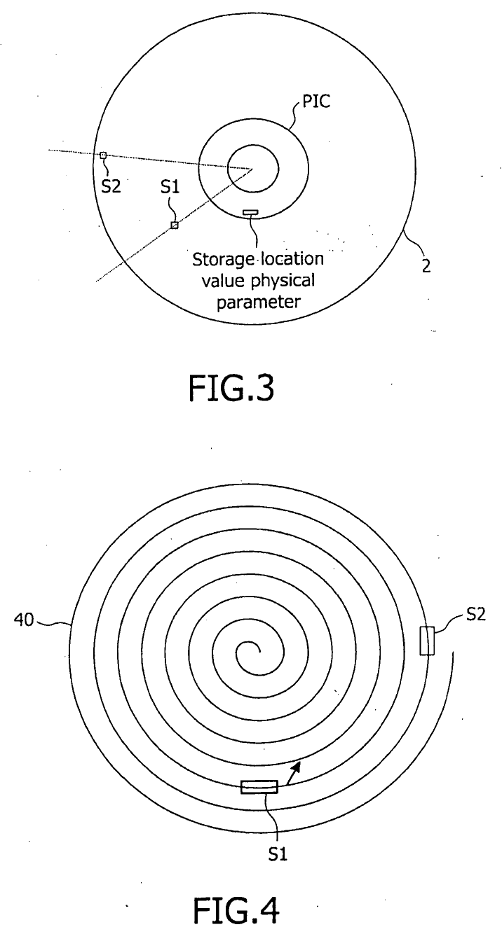

FIG. 3 shows a record carrier with marks that allow the detection of an illegally duplicated record carrier.

FIG. 4 shows the derivation of a 1PPR signal.

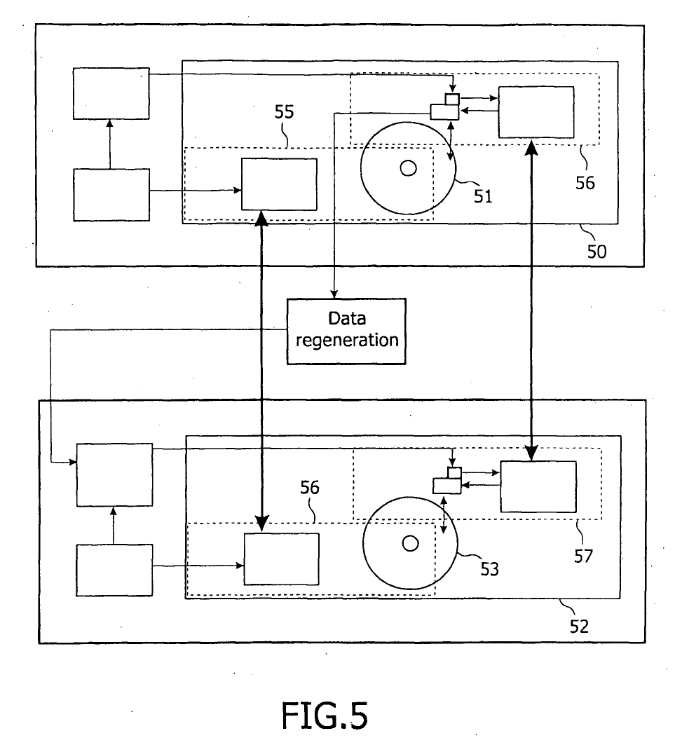

FIG. 5 shows a duplication setup with locked record carrier rotations.

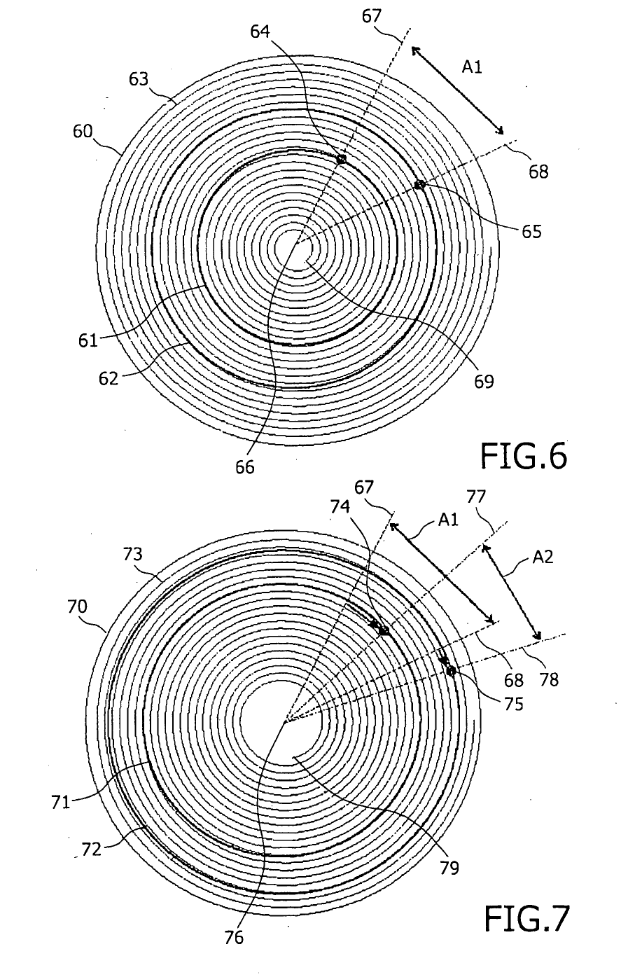

FIG. 6 shows the original record carrier according to the invention comprising the first predefined position and the second predefined position.

FIG. 7 shows the change in angle between the first predefined position and the second predefined position due to the duplication of the record carrier.

FIG. 8 shows the original record carrier according to the invention comprising the first predefined position and the second predefined position.

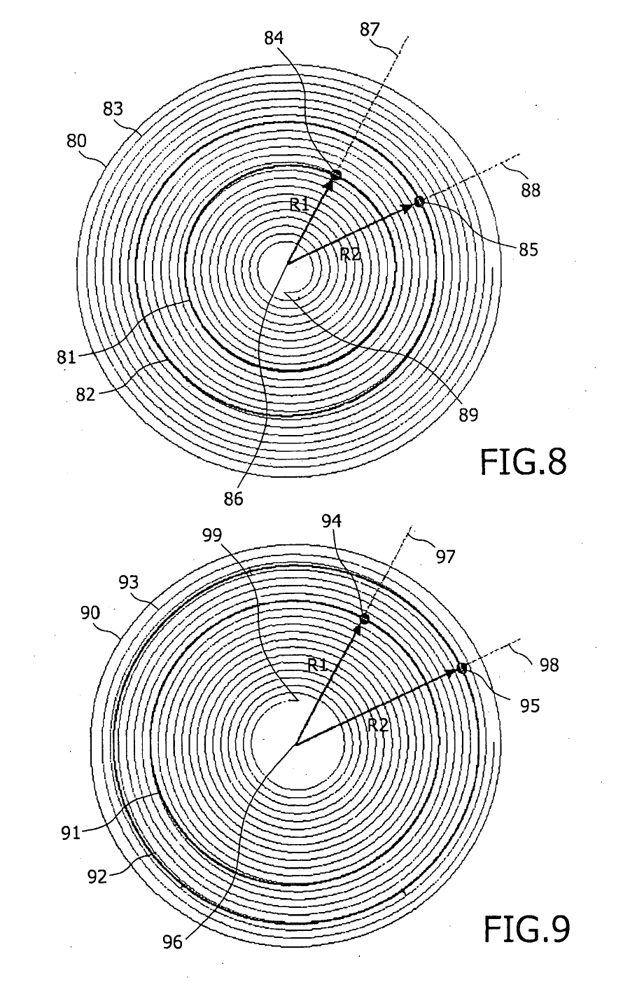

FIG. 9 shows the change in radius of the first predefined position and the second predefined position due to the duplication of the record carrier.

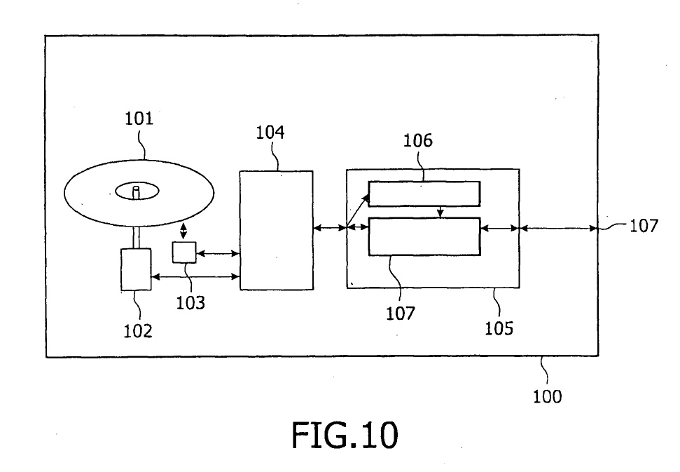

FIG. 10 shows a playback device comprising means for copy right control according to the invention.

When the description refers to a master it implicitly also refers to the record carrier obtained from that master and vice versa.

Further more, even though the description uses the ROM type record carrier to explain the principle behind the invention, an illegal duplication from a ROM type record carrier, having the characteristics as disclosed in this description, to a recordable type record carrier would also result in the detection of the illegal duplication onto the recordable type record carrier.

FIG. 1 shows a regular recording using a mastering machine.

In a state-of-the-art mastering machine 1 the linear velocity of the recording on the master 2 due to rotation of the record carrier 2 and the radial velocity due to the radial movement of the recording head 3 is controlled independently. Two small-bandwidth control loops are present.

The translation control loop 4 comprises a position sensor 5 for providing a measurement of the relative radius r of the optical spot with respect to the rotation axis of the master 2 to the translation controller 6. The systematic error of the position sensor 5 is master machine 1 specific and specified to be within +/−5 um. Currently the radius r from the translation controller 6 is not used as an input for the rotation control loop 7. Therefore the translation control loop 4 and the rotation control loop 7 function fully independently, hence the rotation controller 8 estimates the actual radius by counting the number of revolutions at a given track pitch. At the end of the master session it is checked if the position of the last frame is conform the expected position within a certain margin.

In order to apply a high frequency wobble to the tracks, an optical deflector able to add +/−200 nm track deviation is present in the light beam (not shown).

By supplying the same master clock from a master clock generator 9 to the format generator 10 and the mastering machine 1, the position of data in neighboring tracks can be aligned.

FIG. 2 shows a recording of an original master 2 according to the invention using a mastering machine.

The secure format generator 20 of the master machine 1 uses an externally provided adjustable data delay to delay the actual start of the record carrier data by a data delay device 21. For each master 2 to be produced the data delay can be adjusted differently.

This measure effectively has two effects:

The angular positions between groups of channel bits are shifted because the data starts at a different start position at a different radius of the master 2.

The number of channel bits per track on the master 2 changes.

During mastering the angular positions of groups of specific channel bits and the number of bits per track are measured and stored onto the master 2. A ‘secure’ format generator encodes these values according to a secret algorithm and a record carrier specific key.

The invention is based on the recognition that reproducing the absolute radius of the starting position of a master 2 is virtually impossible. Measuring said two effects and comparing them with the values stored on a record carrier obtained from the master allows the identification of illegally duplicated record carriers.

FIG. 3 shows a record carrier with marks that allow the detection of an illegally duplicated record carrier.

One option, besides using special marks on the record carrier obtained from the master 2, is to use sync words that are already present.

During mastering the relative angular position on the master 2 between at least two sync words S1 and S2 is determined, encoded and stored on the record carrier. For a Blu-Ray Disc ROM it is advantageous to concentrate these actions in the so called PIC band. The format generator and the mastering machine are both coupled to the same master clock generator. Therefore in the format generator the record carrier rotation frequency is known and used for computing the relative sync positions. The relative sync positions can be expressed in units of channel bits or in degrees.

The relative angular sync positions are not affected by the limited absolute accuracy of the starting radius of the master machine if the rotation and translation control loops are locked.

Illegally duplicated record carriers can be recognized by the player by comparing the actual relative angular positions and the positions encoded in the record carrier. For this purpose the relative angular sync positions are measured compared to the record carrier rotation frequency.

As a variant on this embodiment, the position of arbitrary channel words, or arbitrary decoded channel words, or arbitrary error-corrected user data words can be used.

For determining the relative angular positions of the sync words S1 and S2 a reference position signal is useful. In most record carrier players a tacho signal is present, e.g. for controlling the spindle motor, from which a 1-Pulse-Per-revolution (1PPR) signal can be derived by dividing the tacho signal by the number of tacho pulses per revolution.

FIG. 4 shows the derivation of a 1PPR signal.

An artificial 1PPR signal can be derived as follows.

When sync word S1 is detected in a track 40, the reading spot jumps to an adjacent section of the track so that by following the track 40 the sync word S1 is encountered again. The time between 2 successive S1 appearances equals the record carrier revolution time. By keeping the record carrier revolution frequency and thus the record carrier revolution time constant and jumping to the track of S2, the relative position of S2 with respect to S1 can be determined by determining the ratio between the time between the occurrence of the first sync word S1 and the second sync word S2 and the time between the successive appearances of the sync word S1.

FIG. 5 shows a duplication setup with locked record carrier rotations

The source mastering machine 50 is used to read the original record carrier 51. The copy mastering machine 52 is used to record the master 53.

The rotation control loop 55 of the copy mastering machine 52 is locked to the rotation control loop 54 of the source mastering machine 50. This results in the master 53 rotating at the same rotational speed as the original record carrier 51.

In addition the translation control loop 57 of the copy mastering machine is locked to the translation control loop 56 of the source mastering machine 50. This results in the movement of the read head of the source mastering machine 50 being duplicated by the write head of the copy mastering machine 50. The copy mastering machine has an inherent and individual systematic error of the position sensor in the translation control loop 57. Consequently, even though the movement of the write head is synchronized to the movement of the read head of the source mastering machine 50, the absolute position of the write head is not identical to the read head of the source mastering machine 50.

FIG. 6 shows the original record carrier according to the invention comprising the first predefined position and the second predefined position.

The record carrier 60 comprises a spiral track 63. Because the invention equally applies to record carrier with circular tracks and because the spiral track is very dense, it can be considered equivalent to a circular track. Hence in FIG. 6 a first circular track 61 and a second circular track 62 are indicated. On the first circular track 61 a first mark 64 is recorded at a first predefined position. On the second circular track 62 a second mark 65 is recorded at a predefined position. Through the center 66 of the record carrier and the first predefined position 64 a first virtual line 67 is drawn. Through the center 66 of the record carrier and the second predefined position 65 a second virtual line 68 is drawn.

The angle A1 between the first virtual line 67 and the second virtual line 68 is measured and stored on the original record carrier 60 for retrieval during the verification by the playback device. The start 69 of the data is at the standard position for the mastering machine.

FIG. 7 shows the change in angle between the first predefined position and the second predefined position due to the duplication of the record carrier.

To illustrate the result of a shift of the starting point of the data on angle A1 FIG. 7 shows a large shift of the first circular track 71 and the second circular track 72.

It is obvious from FIG. 7 that, compared to FIG. 6, the angle A1 changes when the starting point is moved. Because the bits, at a constant bit density, are stored in longer tracks the first mark 74 and the second mark 75 on the illegally duplicated record carrier will both shift along the track. The distance along the track of the shift is the same for the first mark 74 and the second mark 75, but since the first circular track 71 has a shorter circumference as the second circular track 72, the angular shift of the first mark 74 along the first track 71 is larger than the angular shift of the second mark 75 along the second circular track 72. Thus a change in angle A1 is the inevitable consequence of the illegal duplication. Storing the value of the angle A1 allows the detection of an illegally duplicated record carrier.

FIG. 8 shows the record carrier according to the invention comprising the first predefined position and the second predefined position.

The record carrier 80 comprises a spiral track 83. Because the invention equally applies to record carrier with circular tracks and because the spiral track is very dense, it can be considered equivalent to a circular track. Hence in FIG. 8 a first circular track 81 and a second circular track 82 are indicated. On the first circular track 81 a first mark 84 is recorded at a first predefined position. On the second circular track 82 a second mark 85 is recorded at a predefined position. Through the center 86 of the record carrier and the first mark 84 a first virtual line 87 is drawn. Through the center 86 of the record carrier and the second mark 85 a second virtual line 88 is drawn.

The distance from the center 86 to the first mark 84 is equivalent to the radius R1 of the first circular track 81.

The distance from the center 86 to the second mark 85 is equivalent to the radius R2 of the second circular track 82.

The radii R1, R2 or the ratio of the radii R1, R2 is measured and stored on the original record carrier 80 for retrieval during the verification by the playback device. The start 89 of the data is at the standard position for the mastering machine.

FIG. 9 shows the change in radius of the first predefined position and the second predefined position due to the duplication of the record carrier.

To illustrate the result of a shift of the starting point of the data on the radii R1, R2 FIG. 9 shows a large shift of the first circular track 91 and the second circular track 92.

It is obvious from FIG. 9 that, compared to FIG. 8, the percentage change of the radius R1 of the first circular track 91 is larger than the percentage change of the radius R2 of the second circular track 92. Hence not only the absolute values of the radius R1 of the first circular track 91 and of the radius R2 of the second circular track 92 will change but also the ratio of the radii R1, R2 will change. Thus storing the values of the radii R1, R2 or of the ratio of the radii R1, R2 allows the detection of an illegally duplicated record carrier.

When using a duplication setup where the record carrier rotation of the original and the duplicate record carrier are locked a detection based on the angular positions is not possible because by locking the record carrier rotational frequencies of the source and target illegal duplicated record carrier, data is re-mastered to the correct angular positions. Consider the case of a circle comprising two points on that circle, defining, together with the center of the circle, an angle. If the diameter of the circle is increased, or decreased for that matter, the angle defined by the center of the circle and the two points on the expanded circle will not be changed by the expansion.

However, as shown above, the radii R1, R2 will change due to the change in the starting point of the data, i.e. the same data is recorded at a track at a different distance from the center on the illegally duplicated record carrier compared to the original record carrier.

Using this method the amount of channel bits per track is perfectly copied.

As a result the angle between the sync words S1, S2, or other marks used to define an angle, is perfectly reproduced on the copied record carrier. However, discrepancies between the start radii of the source- and the copied record carrier introduced by tolerances in the relative radius r of the optical spot with respect to the rotation axis of the record carrier in the master machine's, i.e. by the individual systematic error of the position sensor will change the bit-length gradually over the record carrier because the same amount of bits are now spread over one rotation of the record carrier at a larger or smaller radius.

bl_{source}=ν_{source}·T_{bit}=ωᵣₒₜ·r·T_{bit} and bl_{copy}=ν_{copy}·T_{bit}=ωᵣₒₜ·(r+Δr)·T_{bit}

The channel bit-length of the copied bits has changed by Δbl=ωᵣₒₜ·Δr·t_{bit}

The maximum relative bit-length change (percentage wise) occurs at the innerradius (21 mm) and with a 5 um radius variation of the mastering machine, hence

$$\frac{{bl}_{copy}}{{bl}_{source}} {\vert}_{max} = \frac{{r}_{min} + Δ r}{{r}_{min}} = 1 + \frac{Δ r}{{r}_{min}} = 1 + \frac{5 \cdot {10}^{- 6}}{21 \cdot {10}^{- 3}} = 1 + 2 \cdot {10}^{- 4}$$

In order to identify cloned record carriers, the bit-density measured on a particular position on the record carrier is compared to a bit-density value stored securely into the PIC-band.

In addition the changes of bit length can also be measured at two different locations.

For the original record carrier recorded in constant velocity mode the following equations apply:

ω₁r₁=ω₂r₂=V_{scan}

Where ω₁ denotes the angular velocity of the original record carrier when reading the track containing the first mark, ω₂ denotes the angular velocity of the original record carrier when reading the track containing the second mark at the same linear velocity as when reading the track containing the first mark, r₁ denotes the radius of the track where the first mark is located and r₂ denotes the radius of the track where the second mark is located. V_{scan} denotes the scanning velocity which is constant for a constant linear velocity record carrier as used in this calculation.

This is equivalent to:

$$\frac{{ω}_{1}}{{ω}_{2}} = \frac{{r}_{2}}{{r}_{1}}$$

Hence the ω₁ and ω₂ can be used to determine the ratio of r₁ and r₂.

The duplication process, using locked rotation control loops and locked translation control loops, introduces, either because of the systematic error of the machine used to create the duplicate record carrier or because of the purposely introduced offset in the start of the data, an offset in the radii of Δr.

For the duplicated record carrier the above formulas change to:

$${r}_{1}^{′} = {r}_{1} + Δ r$$

$${r}_{2}^{′} = {r}_{2} + Δ r$$

$$\frac{{ω}_{1}}{{ω}_{2}} = \frac{{r}_{2} + Δ r}{{r}_{1} + Δ r}$$

$${V}_{scan} = {ω}_{1} ( {r}_{1} + Δ r ) = {ω}_{2} ( {r}_{2} + Δ r )$$

the difference between the expected value and the measured value becomes:

$$D = \frac{{r}_{2}}{{r}_{1}} - \frac{{r}_{2} + Δ r}{{r}_{1} + Δ r} = \frac{Δ r ( {r}_{2} - {r}_{1} )}{{r}_{1} ( {r}_{1} + Δ r )}$$

Assume r₁=21 mm, r₂=60 mm and Δr=5 μm. This results in a D of 4.4·10⁴.

This difference D is large enough to be detected reliably.

When duplicating the record carrier, for instance using a bit-by-bit duplication process, the angle between the sync words S1 and S2 can be preserved at the cost of a change in bit length, or the bit length can be preserved at the expense of changes in the angle between the sync words S1 and S2, but it is not possible to preserve both at the same time.

Consequently a playback device that checks for both changes in the angle between the sync words S1 and S2, or between other marks, and for changes in bit length can detect an illegally duplicated record carrier with a high certainty. The playback device prevents the use of the illegally duplicated record carrier by preventing the playback of the data stored on the record carrier, rendering the illegally duplicated record carrier useless and preventing the abuse of the copyrighted material by illegally duplicating a record carrier on the mastering level.

One possible method to determine the bit-density is to measure the rotational frequency of the record carrier at a particular user bit rate.

As a variant to this method, the difference in relative bit-density between 2 locations (e.g. between the inner- and outer radius) is used. If the 2 locations are on different tracks the offset in radius introduced by the illegal duplication is equal for both locations.

The offset is however biggest, percentage wise, for the location on that track nearer to the center of the record carrier than for the location on the track further away from the center.

The bit density will thus vary at a different rate, which can be easily detected.

By choosing the first location close to the center of the record carrier and the second location closest to the outer edge of the record carrier the difference in bit-density will be the largest and easiest to detect.

By comparing the record carrier-rotation versus data bit rate relation between different tracks, e.g. between track 1 and track 100, a deviation from the assumed starting radius can be detected. A practical method to implement this measure is by measuring the angular velocity of the record carrier reading the N-th track while maintaining a constant bit rate.

This measurement is most effectively when performed between the first data track and the last data track on the record carrier.

FIG. 10 shows a playback device comprising means for copy right control according to the invention.

The playback device comprises a spindle motor 102 for the rotation of the record carrier 101. The speed of the spindle motor 102 is controlled by the basic engine and the spindle motor is fitted with a tacho for providing feedback on the rotational speed to the basic engine 104. The basic engine further controls the optical pickup unit 103 and retrieves the data from the record carrier by moving the optical pickup unit 103 to the desired position and receiving the retrieved data from the optical pickup unit 103. The basic engine 104 receives commands from the central processing unit 105 and provides the data the basic engine was instructed to retrieve to the central processing unit 105. The central processing unit 105 comprises a copy right control section 106 and a regular data processing section 107. The central processing unit 105 provides copy right related information, such as the measured physical parameter to the copy right control section 106. Regular data is provided to the regular data processing section 107. The copy right control section 106 determines, as described above, whether the measured physical parameter complies with the stored value retrieved from the record carrier 101. If the measured physical parameter complies with the stored value retrieved from the record carrier 101 the copy right control section authorizes the regular data processing section to process the regular data. If the measured physical parameter does not comply with the stored value retrieved from the record carrier 101 the copy right control section instructs the regular data processing section to not process the regular data. Access to the data on an illegally duplicated record carrier is thus prevented.

As outlined above the playback device 100 must be able to measure certain parameters on the record carrier 101.

To determine the bit-density the playback device measures the rotational frequency of the record carrier at a particular user-bitrate. The basic engine 104 adjusts the rotational speed of the spindle motor 102 until the desired bit rate is received through the optical pickup unit 103. The tacho in the spindle motor is subsequently used to determine the rotational speed and the rotational frequency.

As a variant to this method, the maximal relative bit-density between 2 locations (e.g. between the inner- and outer radius) is used. If the 2 locations are on different tracks the offset in radius introduced by the illegal duplication is equal for both locations.

The offset is however biggest, percentage wise, for the location on that track nearer to the center of the record carrier than for the location on the track further away from the center.

The bit density will thus vary at a different rate, which can be easily detected.

In order to detect this the basic engine 104 fixes the rotational speed of the spindle motor 102, moves the optical pickup unit 103 to a first predetermined position and measures the bit density at this position. The optical pickup unit 103 is subsequently moved to another predetermined position by the basic engine 104 and the bit density is determined. These values are passed to the copy right control section 106 of the central processing unit 105 together with the stored value as retrieved from the record carrier 101.

The copy right control section can determine, based on this information, whether the record carrier in the player is an illegal duplicate or original record carrier.

The playback device can also measure the angular variation.

Illegally duplicated record carriers can be recognized by the player by comparing the actual relative angular positions and the positions encoded in the record carrier. For this purpose the basic engine 104 determines the relative angular sync positions. The time needed for the spindle motor 102 to rotate the record carrier once can be determined by the basic engine 104 by measuring the time lapsing between two subsequent occurrences of the same sync word. Subsequently the basic engine 104 moves the optical pickup unit 103 to the track where the first sync word that determines the angle is located. The basic engine 104 waits are until the first sync word occurs and immediately jumps to the track where the second sync word that determines the angle is located and determines the time that lapses until the second sync word occurs. The ratio of the two lapsed times allows the calculation of the angle between the two positions by the copy right control section 106.

As a variant on this embodiment, instead of the sync words, the position of arbitrary channel words, or arbitrary decoded channel words, or arbitrary error-corrected user data words can be used.

For determining the relative angular positions of the sync words S1 and S2 a reference position signal is useful as can be obtained from the tacho of the spindle motor 102. In most record carrier players this tacho signal is present, e.g. for controlling the spindle motor, from which a 1-Pulse-Per-revolution (1PPR) signal can be derived by dividing the tacho signal by the number of tacho pulses per revolution.

1. Record carrier comprising record carrier identification information
characterized in that the record carrier identification comprises a value indicating a physical parameter of that record carrier and in that the physical parameter represents a relation between a first pre-defined position on the record carrier and a second pre-defined position on the record carrier.

2. Record carrier as claimed in claim 1,
characterized in that the physical parameter is an angle between a first line crossing the first pre-defined position perpendicular to a reading direction and a second line crossing the second pre-defined position perpendicular to the reading direction.

3. Record carrier as claimed in claim 1,
characterized in that the physical parameter is a difference between a first radius at which the first pre-defined position is located and a second radius at which the second pre-defined position is located.

4. Record carrier as claimed in claim 1,
characterized in that the physical parameter is a bit length.

5. Record carrier as claimed in claim 1,
characterized in that the physical parameter is a number of bits per revolution.

6. Record carrier as claimed in claim 1,
characterized in that the record carrier comprises a track with a shifted starting point relative to a standardized starting point on a standardized record carrier.

7. Record carrier as claimed in claim 6,
characterized in that the shifted starting point is shifted in a direction towards an end of the track.

8. Playback device comprising a retrieval device for retrieving record identification information from a record carrier, characterized in that the retrieval device is arranged to retrieve a value indicating a physical parameter of that record carrier and in that the physical parameter represents a relation between a first pre-defined position on the record carrier and a second pre-defined position on the record carrier and that the playback device further comprises a verification device for comparing the retrieved value to a measured value of the physical parameter as measured on the record carrier by a measuring device comprised in the playback device.

9. Playback device as claimed in claim 8,
characterized in that the physical parameter is an angle between a first line crossing the first pre-defined position perpendicular to a reading direction and a second line crossing the second pre-defined position perpendicular to the reading direction.

10. Playback device as claimed in claim 8,
characterized in that the physical parameter is a difference between a first radius at which the first pre-defined position is located and a second radius at which the second pre-defined position is located.

11. Playback device as claimed in claim 8,
characterized in that the physical parameter is a bit length.

12. Playback device as claimed in claim 8,
characterized in that the physical parameter is a number of bits per revolution.

13. Playback device as claimed in claim 9.

14. Playback device as claimed in claim 11.

15. Playback device as claimed in claim 6,
characterized in that the verification device prevents an operation of the playback device if a difference is detected between the retrieved value and the measured value.

16. Playback device as claimed in claim 8,
characterized in that the retrieval device comprises a device for decrypting the value indicating a physical parameter of that record carrier when retrieving the value indicating a physical parameter of that record carrier from the record carrier.
